(19) United States
(12) Patent Application Publication
(10) Pub. No.: US 2021/0108736 A1
(43) Pub. Date: Apr. 15, 2021

(54) CHECK VALVE

(71) Applicants: Do Seo Park, Houston, TX (US); Zhi Yong He, Cypress, TX (US)

(72) Inventors: Do Seo Park, Houston, TX (US); Zhi Yong He, Cypress, TX (US)

(73) Assignee: Baker Hughes Oilfield Operations LLC, Houston, TX (US)

(21) Appl. No.: 16/597,623

(22) Filed: Oct. 9, 2019

(51) Int. Cl. F16K 27/02

(52) U.S. Cl. CPC F16K 27/0209

(57) ABSTRACT

A check valve including a first housing having a first seat; a dart disposed at least partially within the first housing and interactive with the seat to selectively create a fluid seal; a second housing disposed at least partially about the first housing, the second housing having a second seat, the first housing interactive with the second seat to selectively create a fluid seal; a first biasing member configured to bias the dart to a sealed position with the first seat; and a second biasing member configured to bias the first housing to a sealed position with the second seat.

### BACKGROUND

In the resource recovery industry, there are many needs to promote or allow flow of fluid in one direction while preventing flow in the opposite direction. Check valves are common for this use. While there are different types of check valves, various design factors promote differing advantages and detriments. One such detriment is a dart of the valve becoming stuck in the valve seat. When this occurs, it the dart cannot be dislodged, the valve is nonfunctional and must be removed from the system in order to reinitiate its function. In the resource recovery industry, removing and replacing a component can be monumentally expensive doe to many of such components being in service in a downhole environment many thousands of feet from the surface. Significant time, effort and expense are involved in simply retrieving the valve for remediation thereof. The art would well receive innovations that reduce or eliminate the issues noted above.

### SUMMARY

An embodiment of a check valve including a first housing having a first seat, a dart disposed at least partially within the first housing and interactive with the seat to selectively create a fluid seal, a second housing disposed at least partially about the first housing, the second housing having a second seat, the first housing interactive with the second seat to selectively create a fluid seal, a first biasing member configured to bias the dart to a sealed position with the first seat, and a second biasing member configured to bias the first housing to a sealed position with the second seat.

An embodiment of a wellbore including a borehole, a tubular system disposed within the borehole, a valve as in any prior embodiment disposed in the tubular system.

### BRIEF DESCRIPTION OF THE DRAWINGS

The following descriptions should not be considered limiting in any way. With reference to the accompanying drawings, like elements are numbered alike:

FIG. 1 is a cross sectional view of an embodiment of a check valve as disclosed herein in a first flow position;

FIG. 2 is a cross sectional view of the embodiment of the check valve illustrated in FIG. 1 in a second flow position; and

FIG. 3 is a schematic view of a wellbore employing a valve as described herein.

### DETAILED DESCRIPTION

A detailed description of one or more embodiments of the disclosed apparatus and method are presented herein by way of exemplification and not limitation with reference to the Figures.

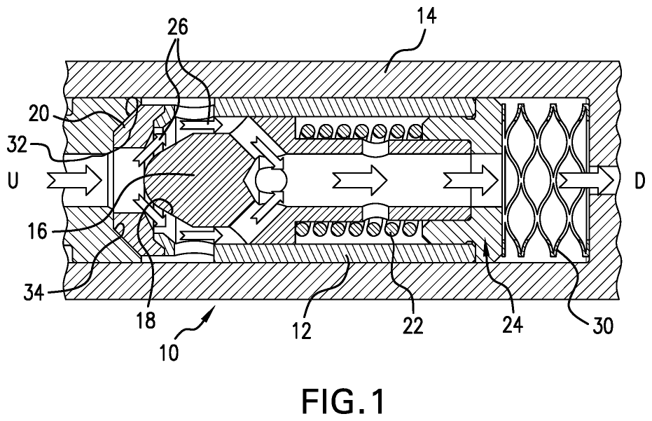

Referring to Figure, a check valve 10 is illustrated. The valve 10 includes a first housing 12 slidingly disposed in a second housing 14. Within the first housing 12 is slidingly disposed a dart 16. Dart 16 includes a flow path 17 (arrows showing flow) for fluid movement through the dart 16. Further the dart 16 includes a seal area 18 that is intended to matingly contact a seat 20, which may be constructed of a resilient material. The seal area 18 interacts with the seat 20 to prevent fluid flow past the dart in either axial direction (using the longitudinal axis of the dart as a frame of reference). The dart 16 is biased to the fluid flow inhibiting position by a first biasing member 22 that is buttressed by a cap 24 connected to the first housing 12 in a retentive manner such as by press fitting, threading, adhesive, welding, etc. Upon the application of fluid pressure from the upstream side of the valve 10 denoted by capital letter U, the dart 16 may be urged against the bias of the first biasing member 22 and off the seat 20 to allow fluid to pass the dart 16. In an embodiment, the pressure differential between U and a downstream area D to move dart 16 off seat 20 is about 150 psi. As an example, the fluid flow with the dart 16 off seat 20 is illustrated in FIG. 1 by arrows 26.

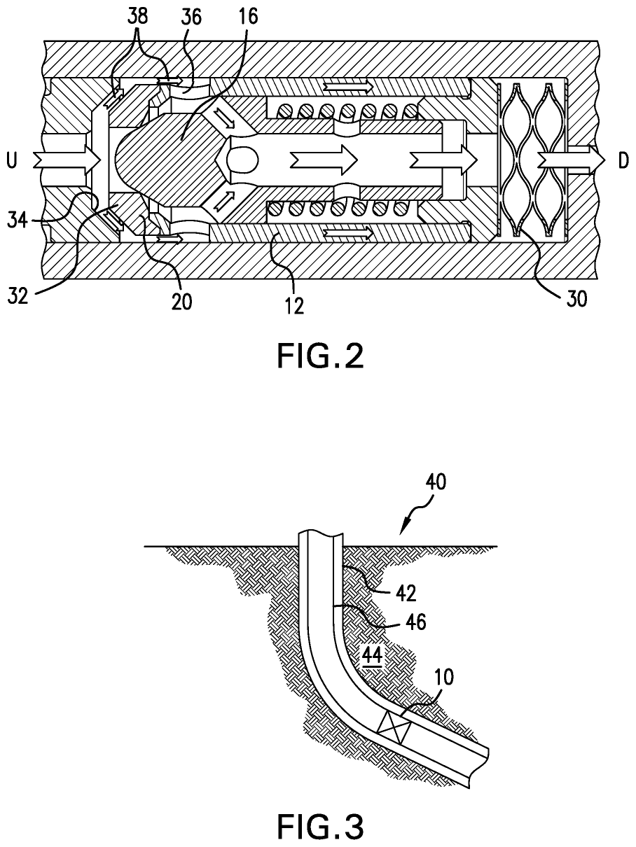

The valve function as described above will be quite serviceable for extended periods of time but in some situations, it is possible for the dart 16 to become stuck in a position where the dart 16 remains sealed to the seat 20. This would be a grave problem in the prior art as noted above but for the valve disclosed herein, this does not present a major impediment to continued operation. Rather, the first housing 12 is as noted, slidingly disposed in the second housing 14. A second biasing member 30 is disposed within the second housing 14 and in biasing contact with the cap 24. As such, the first housing and all contents therewithin are urged in the upstream direction by the second biasing member 30. It is to be appreciated that the seat 20 is actually a part of the first housing and so will move with the first housing. The bias of the second biasing member therefore is used to urge a seal area 32 of the seat 20 into contact with a second seat 34. Upon a differential pressure of for example about 1000 psi from U to D, the second biasing member 30 will be overcome thereby allowing the seal area 32 to move away from the second seat 34 and allow fluid to flow around the seat 20, through openings 36 in the first housing 12 and downstream of the valve 10. This flow may be visualized by referring to FIG. 2 and reviewing arrows 38.

As will be appreciated, the operation of the valve 10 will proceed normally at normal cracking threshold pressures associated with the first biasing member 22 until and unless the dart 16 becomes inoperative (e.g. stuck in the first seat) at which point operation of the valve 10 may be continued simply by increasing the actuation pressure to the second cracking threshold pressure associated with the second biasing member 30. Resultingly, there is no need to retrieve and remediate the valve 10 but rather operations may be continued while avoiding the expense and down time associated with retrieval and remediation.

In an embodiment, referring to FIG. 3, a wellbore 40 comprises a borehole 42 in a formation 44, a tubular system 46 disposed within the borehole 42 and a valve 10 as disclosed above disposed in the tubular system. The wellbore 40 is superior to its predecessors in that fluid injection (e.g. chemical injection) may proceed even after the dart 16 become inoperative due to scale, etc.

Set forth below are some embodiments of the foregoing disclosure:

Embodiment 1: A check valve including a first housing having a first seat; a dart disposed at least partially within the first housing and interactive with the seat to selectively create a fluid seal; a second housing disposed at least partially about the first housing, the second housing having a second seat, the first housing interactive with the second seat to selectively create a fluid seal; a first biasing member configured to bias the dart to a sealed position with the first seat; and a second biasing member configured to bias the first housing to a sealed position with the second seat.

Embodiment 2: The valve as in any prior embodiment wherein the first housing defines openings therein to allow fluid to move radially through the first housing in a position of the valve.

Embodiment 3: The valve as in any prior embodiment wherein the housing includes a cap against which the first biasing member is disposed.

Embodiment 4: The valve as in any prior embodiment wherein the first biasing member maintains the dart in sealing connection with the first seat at differential pressures less than a first threshold pressure and the second biasing member maintains the first housing in sealing connection with the second seat at differential pressures less than a second threshold pressure.

Embodiment 5: The valve as in any prior embodiment wherein the second threshold pressure is higher than the first threshold pressure.

Embodiment 6: The valve as in any prior embodiment wherein the first threshold pressure is about 150 psi and the second threshold pressure is about 1000 psi.

Embodiment 7: The valve as in any prior embodiment wherein the first seat comprises a resilient material.

Embodiment 8: The valve as in any prior embodiment wherein the first seat at an opposite surface from the surface that interacts with the dart, has a second surface that interacts with the second seat.

Embodiment 9: A method for injecting a fluid into a target environment through the valve as in any prior embodiment including creating a pressure differential across the dart and first seat of greater than a first threshold pressure; and increasing differential pressure across the first housing and the second seat to greater than a second threshold pressure.

Embodiment 10: The method as in any prior embodiment wherein the increasing differential pressure is carried out after the dart becomes nonresponsive to the first threshold pressure.

Embodiment 11: A wellbore including a borehole; a tubular system disposed within the borehole; a valve as in any prior embodiment disposed in the tubular system.

The use of the terms “a” and “an” and “the” and similar referents in the context of describing the invention (especially in the context of the following claims) are to be construed to cover both the singular and the plural, unless otherwise indicated herein or clearly contradicted by context. Further, it should be noted that the terms “first,” “second,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity and up to 10 deviation from the stated number).

The teachings of the present disclosure may be used in a variety of well operations. These operations may involve using one or more treatment agents to treat a formation, the fluids resident in a formation, a wellbore, and/or equipment in the wellbore, such as production tubing. The treatment agents may be in the form of liquids, gases, solids, semi-solids, and mixtures thereof. Illustrative treatment agents include, but are not limited to, fracturing fluids, acids, steam, water, brine, anti-corrosion agents, cement, permeability modifiers, drilling muds, emulsifiers, demulsifiers, tracers, flow improvers etc. Illustrative well operations include, but are not limited to, hydraulic fracturing, stimulation, tracer injection, cleaning, acidizing, steam injection, water flooding, cementing, etc.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

What is claimed is:

1. A check valve comprising:
a first housing having a first seat;
a dart disposed at least partially within the first housing and interactive with the seat to selectively create a fluid seal;
a second housing disposed at least partially about the first housing, the second housing having a second seat, the first housing interactive with the second seat to selectively create a fluid seal;
a first biasing member configured to bias the dart to a sealed position with the first seat; and
a second biasing member configured to bias the first housing to a sealed position with the second seat.

2. The valve as claimed in claim 1 wherein the first housing defines openings therein to allow fluid to move radially through the first housing in a position of the valve.

3. The valve as claimed in claim 1 wherein the first housing includes a cap against which the first biasing member is disposed.

4. The valve as claimed in claim 1 wherein the first biasing member maintains the dart in sealing connection with the first seat at differential pressures less than a first threshold pressure and the second biasing member maintains the first housing in sealing connection with the second seat at differential pressures less than a second threshold pressure.

5. The valve as claimed in claim 4 wherein the second threshold pressure is higher than the first threshold pressure.

6. The valve as claimed in claim 5 wherein the first threshold pressure is about 150 psi and the second threshold pressure is about 1000 psi.

7. The valve as claimed in claim 1 wherein the first seat comprises a resilient material.

8. The valve as claimed in claim 1 wherein the first seat at an opposite surface from the surface that interacts with the dart, has a second surface that interacts with the second seat.

9. A method for injecting a fluid into a target environment through the valve as claimed in claim 1 comprising:
creating a pressure differential across the dart and first seat of greater than a first threshold pressure; and
increasing differential pressure across the first housing and the second seat to greater than a second threshold pressure.

10. The method as claimed in claim 9 wherein the increasing differential pressure is carried out after the dart becomes nonresponsive to the first threshold pressure.

11. A wellbore comprising:
a borehole;
a tubular system disposed within the borehole;
a valve as claimed in claim 1 disposed in the tubular system.
